(19) United States
(12) Patent Application Publication
(10) Pub. No.: US 2013/0049930 A1
(43) Pub. Date: Feb. 28, 2013

(54) EMERGENCY GUIDING SYSTEM AND METHOD

(71) Applicant: SHIH-CHENG WANG, Tu-Cheng (TW)

(72) Inventor: SHIH-CHENG WANG, Tu-Cheng (TW)

(73) Assignee: HON HAI PRECISION INDUSTRY CO., LTD., Tu-Cheng (TW)

(21) Appl. No.: 13/219,727

(22) Filed: Aug. 29, 2011

(51) Int. Cl. G08B 25/00

(52) U.S. Cl. 340/8.1

(57) ABSTRACT

An emergency guiding system is provided. The emergency guiding system includes a database unit, a determination unit, and a control unit. The determination unit receives an alarm signal from a hazard processing apparatus including a plurality of sensors, wherein the alarm signal includes status information of the actuated sensors. The database unit includes a plurality of predetermined guiding schemes corresponding to the sensors. After the determination unit chooses one of the predetermined guiding schemes according to the status information of the actuated sensors in the alarm signal, the control unit performs an operation according to the chosen predetermined guiding scheme. The disclosure further provides an emergency guiding method.

### BACKGROUND

1. Technical Field

The present disclosure relates to an emergency guiding system and an emergency guiding method, and particularly to an emergency guiding system and an emergency guiding method using predetermined guiding schemes.

2. Description of Related Art

In a conventional emergency guiding system, evacuation routes are generally shown in a static manner and cannot be updated according to the instant situation of the emergency. As a result, the administrator of the conventional emergency guiding system is often incapable of providing adapted evacuation guidance during emergency.

What is needed, therefore, is an emergency guiding system capable of overcoming the limitation described.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an emergency guiding system of the present disclosure.

FIG. 2A is a schematic view of using the output unit of the emergency guiding system of FIG. 1 to display a guide map with evacuation route.

FIG. 2B is a schematic view of using the output unit of the emergency guiding system of FIG. 1 to display a guide map with refuge route.

FIG. 3A/3B is a block diagram of another embodiment of an emergency guiding system of the present disclosure.

FIG. 4A is a flowchart of an embodiment of an emergency guiding method of the present disclosure.

FIG. 4B is a flowchart of an embodiment of choosing the step of the emergency guiding method of FIG. 4A.

### DETAILED DESCRIPTION

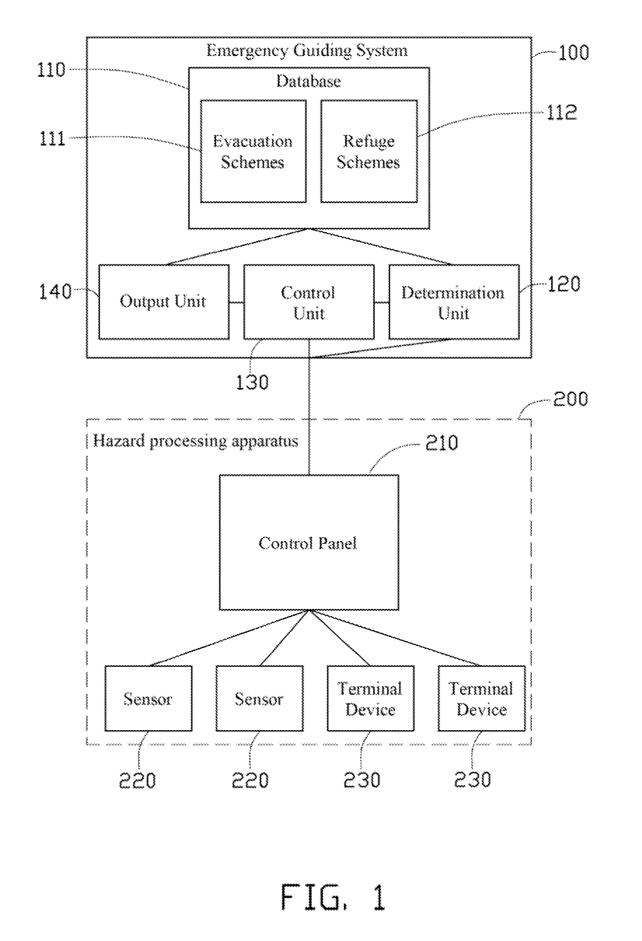

FIG. 1 is a block diagram of an embodiment of an emergency guiding system of the present disclosure. As shown in FIG. 1, an emergency guiding system 100 includes a database 110, a determination unit 120, a control unit 130, and an output unit 140. The emergency guiding system 100 is installed in an electronic device such as a server. In the illustrated embodiment, the emergency guiding system 100 is applied to the emergency guiding of a fire hazard. In other embodiments, the emergency guiding system 100 can be applied to other type of emergency such as illegal entry.

The emergency guiding system 100 is coupled to a hazard processing apparatus 200. The hazard processing apparatus 200 includes a control panel 210, a plurality of sensors 220, and a plurality of terminal devices 230, wherein the sensors 220 and the terminal devices 230 are coupled to the control panel 210, while the control panel 210 is coupled to the emergency guiding system 100. In the illustrated embodiment, the emergency guiding system 100 is coupled to the control panel 210 of the hazard processing apparatus 200 through a RS-232 interface. In addition, the terminal devices 230 can be alarms such as buzzers. In other embodiments, the sensors 220 and/or the terminal devices 230 can be coupled to the emergency guiding system 100 directly, and the emergency guiding system 100 can be coupled to the hazard processing apparatus 200 through other types of interfaces such as Ethernet interface. In addition, the terminal devices 230 can be other types of devices such as fire extinguishers, for fire safety related conditions. When an event such as smoke is detected by the sensors 220 of the hazard processing apparatus 200, the sensors 220 transmit a report signal S_{R} (not shown) corresponding to the event to the control panel 210. The control panel 210 transmits an alarm signal Sₐ (not shown) including status information Iₛ (not shown) of the actuated sensors 220 corresponding to the report signal S_{R} to the emergency guiding system 100.

In the illustrated embodiment, the database 110 includes a plurality of evacuation schemes 111 and a plurality of refuge schemes 112 corresponding to the sensors 220 of the hazard processing apparatus 200, wherein the evacuation schemes 111 and the refuge schemes 112 are predetermined schemes for emergency guiding. In addition, the evacuation schemes 111 and the refuge schemes 112 are determined according to the status of the sensors 220 such as the location, the type, the detected parameters, or the actuation time of the sensors 220. Each of the evacuation schemes 111 and the refuge schemes 112 includes various sets of the status of the sensors 220 which are essential conditions in choosing the schemes, and a list of the terminal devices 230 to be enabled. In other embodiments, the database 110 can include other types of predetermined guiding schemes. In addition, the evacuation schemes 111 and the refuge schemes 112 can be determined according to other parameters relating to the sensors 220, and each of the evacuation schemes 111 and the refuge schemes 112 can include other types of parameters.

The determination unit 120 receives the alarm signal Sₐ from the control panel 210 of the hazard processing apparatus 200. In the illustrated embodiment, the determination unit 120 determines whether there is a possibility to evacuate according to the status of the actuated sensors 220 such as the location, the type, the detected parameters, or the actuation order of the actuated sensors 220. If there is a possibility to evacuate (that is, there is a path to escape from the scene of emergency), the determination unit 120 chooses one of the evacuation schemes 111 according to the status information Iₛ of the actuated sensors 220 in the alarm signal Sₐ. If there is no possibility to evacuate (that is, there is no path to escape from the scene of emergency), the determination unit 120 chooses one of the refuge schemes 112 according to the status information Iₛ of the actuated sensors 220 in the alarm signal Sₐ. In other embodiments, the determination unit 120 can choose one of the schemes in the database 110 by other methods such as according to an instruction received from the user.

After the determination unit 120 chooses one of the evacuation schemes 111 or the refuge schemes 112, the control unit 130 performs an operation according to the chosen scheme, thereby responding to the event. In the illustrated embodiment, the operation of the control unit 130 includes transmitting a control signal S_{c} (not shown) to the control panel 210 of the hazard processing apparatus 200, thereby enabling the terminal devices 230 of the hazard processing apparatus 200 in the list of the terminal devices 230. The operation of the control unit 130 further includes enabling the output unit 140 to output a warning message including a timer of allowable evacuation time, wherein the allowable evacuation time is provided corresponding to the status information Iₛ of the actuated sensors 220 in the alarm signal Sₐ. The output unit 140 includes a display and/or a speaker which outputting the warning message as an image and/or a voice, respectively.

The disclosed emergency guiding system utilizes the determination unit 120 to choose one of the evacuation schemes 111 or the refuge schemes 112 according to the status information of the actuated sensors 220 in the alarm signal Sₐ, such that evacuation routes can be shown in a dynamic manner and updated corresponding to the instant situation of emergency. Consequently, the administrator of the emergency guiding system can provide real time evacuation guidance during emergency.

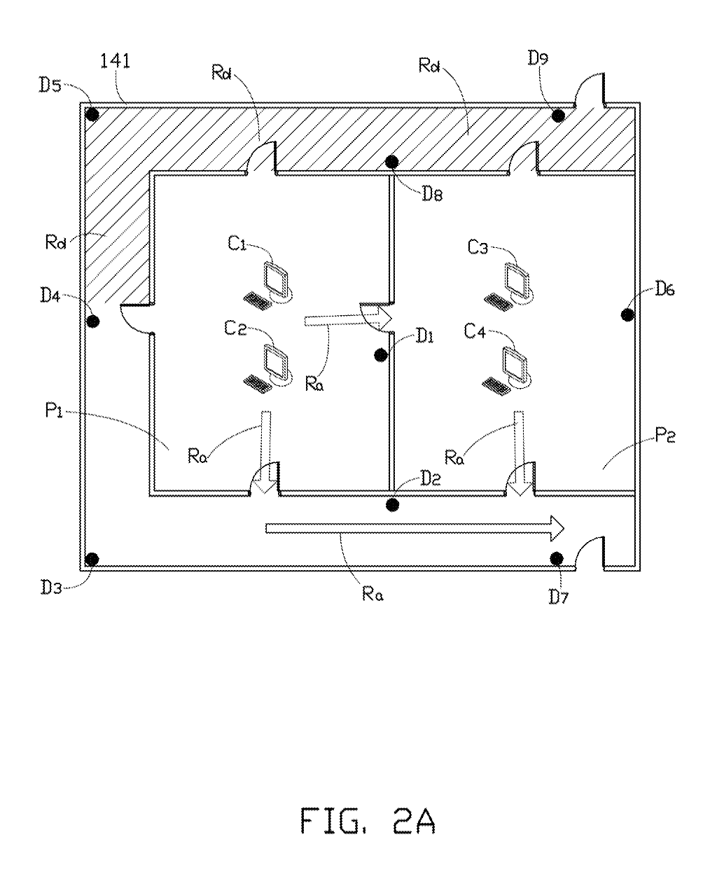

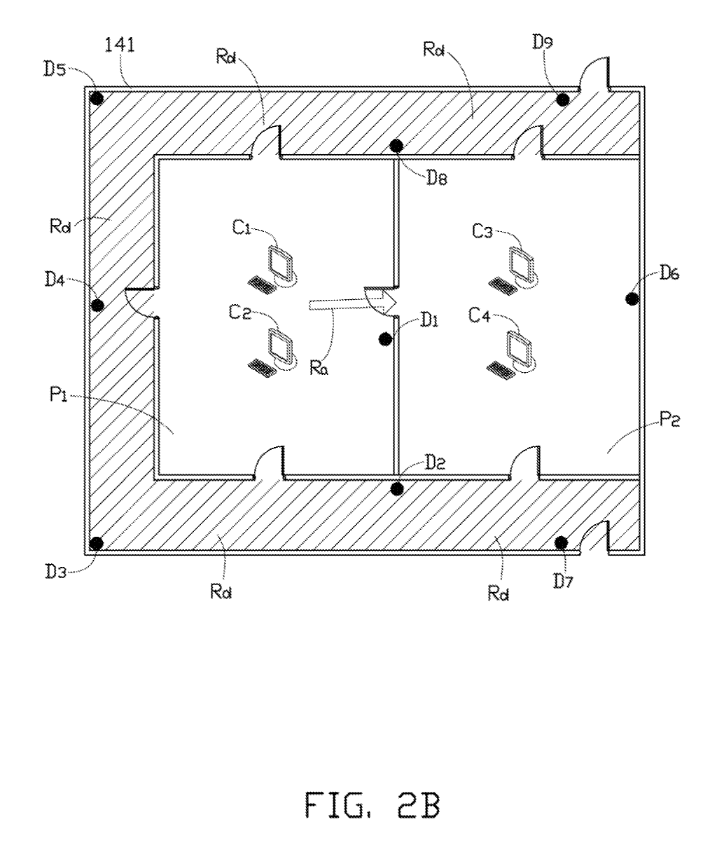

FIG. 2A is a schematic view of using the output unit of the emergency guiding system of FIG. 1 to display a guide map with evacuation route. As shown in FIG. 1 and FIG. 2A, the operation of the control unit 130 includes enabling the output unit 140 such as a display to display a guide map according to the chosen scheme. In the illustrated embodiment, the guide map includes a floor plan 141 corresponding to the scene where the sensors 220 are located, wherein the location of the sensors 220 are represented as dots D on the floor plan 141. The floor plan 141 includes allowed routes Rₐ and disallowed routes R_{d} which are distinguishably displayed from each other. In the illustrated embodiment, since there is a possibility to evacuate from the floor plan 141 through an exit at the bottom-right corner of the floor plan 141, paths for evacuating through the exit are provided through the allowed routes Rₐ, thereby guiding the people in the floor plan 141 to escape from the floor plan 141. In addition, the operation of the control unit 130 further includes transmitting the control signal S_{c} (not shown) for informing clients of a protection region P, wherein one sensor 220 corresponds to at least one protection region P, while the clients can be electronic devices such as computers or mobile phones. In the illustrated embodiment, the sensors 220 represented by dots D₁ to D₅ correspond to a first protection region P₁, and the sensors 220 represented by dots D₆ to D₉ correspond to a second protection region P₂. Since the sensors 220 represented by dots D₅, D₈, and D₉ correspond to the first protection region P₁ and the second protection region P₂ when actuated, a first client C₁ and a second client C₂ corresponding to the first protection region P₁ as well as a third client C₃ and a fourth client C₄ corresponding to the second protection region P₂ will be informed. The user of the clients can be informed by enabling the display of the clients to display a guide map including the floor plan 141, wherein the floor plan 141 includes the allowed routes Rₐ, the disallowed routes R_{d} and individual exits of the first protection region P₁ and the second protection region P₂. In addition, the user of the clients can be informed by other methods such as enabling the speakers of the clients to provide an evacuative instruction.

FIG. 2B is a schematic view of using the output unit of the emergency guiding system of FIG. 1 to display a guide map with refuge route. As shown in FIG. 1 and FIG. 2B, in the illustrated embodiment, since there is no possibility to evacuate from the floor plan 141 through the exits of the floor plan 141, a path to the second protection region P₂ is provided through the allowed route Rₐ, thereby guiding the people in the floor plan 141 to stay in one location and wait to be rescued.

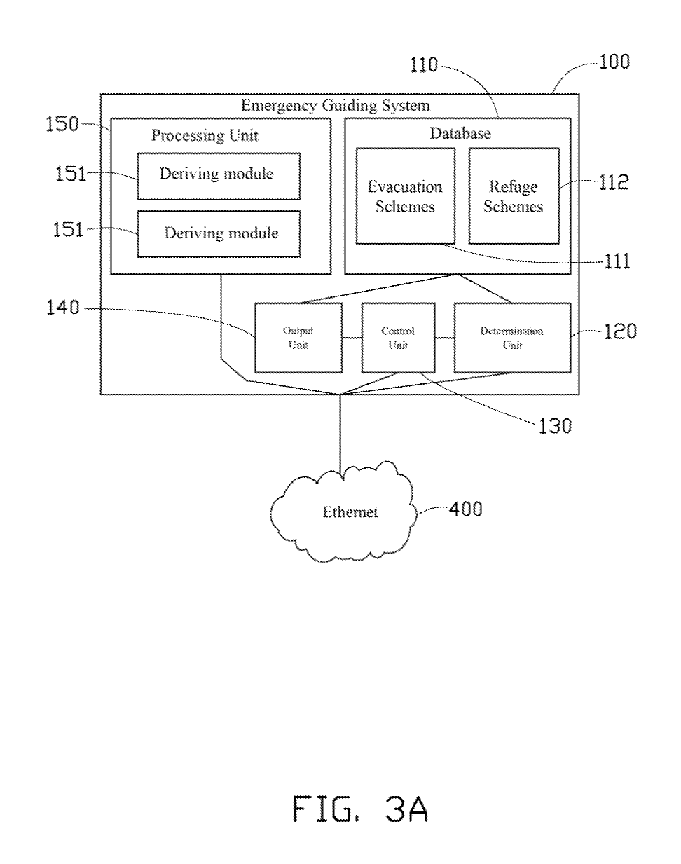

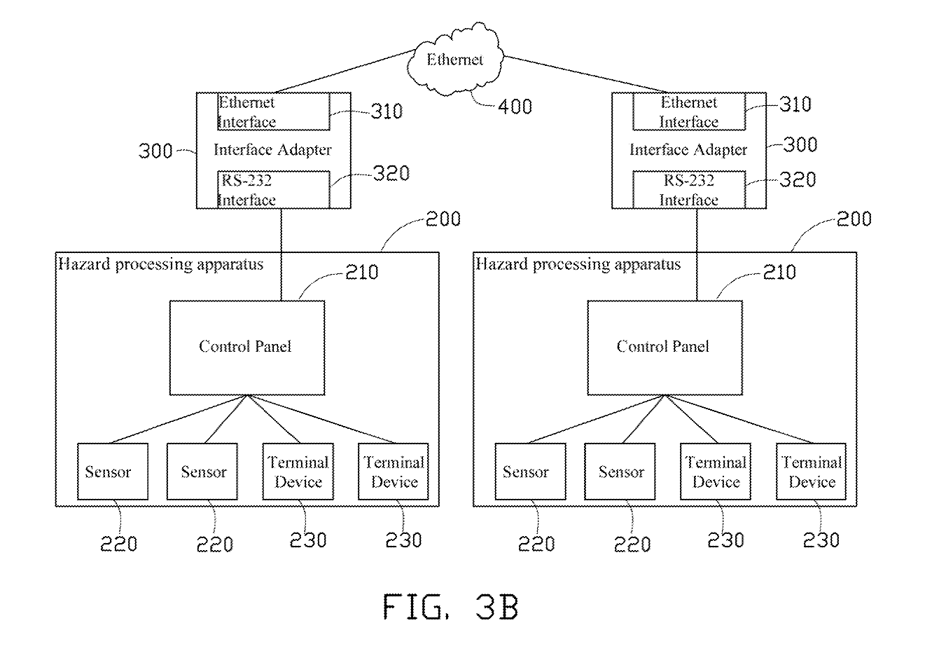

FIG. 3A/3B is a block diagram of another embodiment of an emergency guiding system of the present disclosure. As shown in FIG. 3A/3B, in comparison with the embodiment of FIG. 1, the emergency guiding system 100 further includes a processing unit 150, and is coupled to the hazard processing apparatuses 200 through interface adapters 300. In the illustrated embodiment, each of the interface adapters 300 includes an Ethernet interface 310 and a RS-232 interface 320. In other embodiments, each of the interface adapters 300 can include other types of computer network interfaces such as wireless local area network (WLAN) interface and other types of serial communication interfaces such as RS-485 interface. The Ethernet interface 310 is coupled to the emergency guiding system 100, and the RS-232 interface 320 is coupled to the control panel 210 of the corresponding hazard processing apparatus 200, thereby transforming signals transferred between the emergency guiding system 100 and the corresponding hazard processing apparatus 200 to adapt to the corresponding interfaces. The processing unit 150 of the emergency guiding system 100 includes two deriving modules 151 corresponding to the control panel 210 of the hazard processing apparatuses 200, respectively. The deriving modules 151 derive status information Iₕ (not shown) of the hazard processing apparatuses 200 from an Ethernet signal S_{E} (not shown) received from the interface adaptors 20, which corresponds to the alarm signal Sₐ, and produces the Ethernet signal S_{E} including a control instruction for the hazard processing apparatuses 200. The status information Iₕ may include the status information Iₛ of the actuated sensors 220 of the hazard processing apparatuses 200.

In the illustrated embodiment, the control panels 210 are different types of control panels, which have individual status information format and individual control instruction format. Since the emergency guiding system 100 has the deriving modules 151 each corresponds to each of the control panels 210, the emergency guiding system 100 can recognize the status of the hazard processing apparatuses 200, while the status information of the control panels 210 have different formats. And the emergency guiding system 100 can control the hazard processing apparatuses 200, while the control instructions of the control panels 210 have different formats.

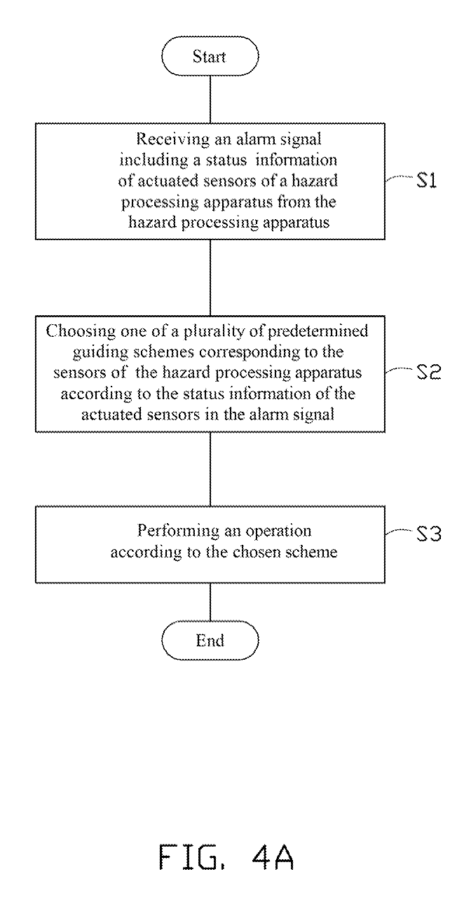

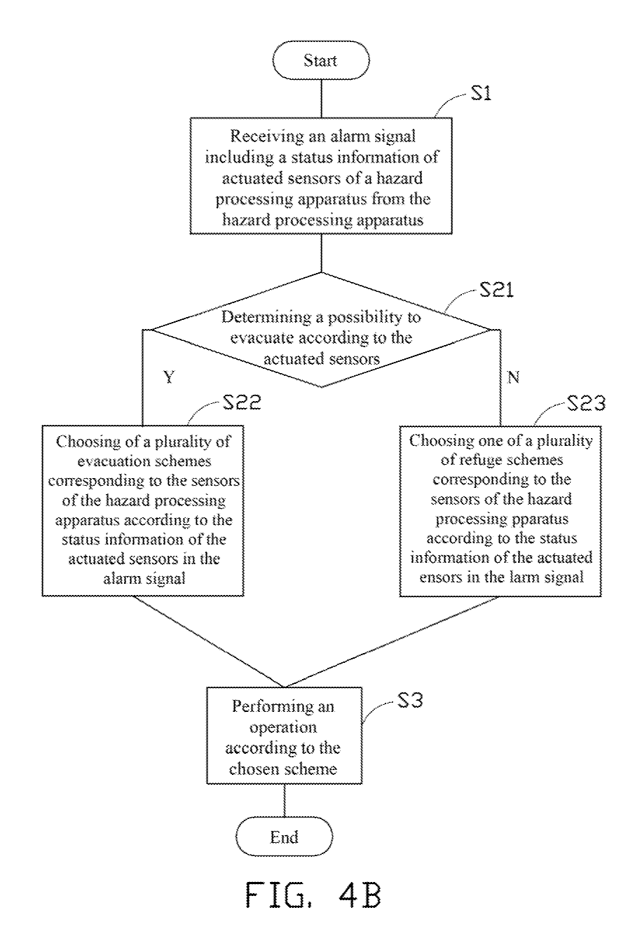

FIG. 4A is a flowchart of an embodiment of an emergency guiding method of the present disclosure. As shown in FIG. 4A, the emergency guiding method of the present disclosure is as follows. Depending on the embodiment, additional steps may be added, others removed, and the ordering of the steps may be changed.

In step S1, an alarm signal including status information of actuated sensors of a hazard processing apparatus 200 is received from the hazard processing apparatus 200. In the illustrated embodiment, the emergency guiding method is applied to the emergency guiding of a fire hazard. In other embodiments, the emergency guiding method can be applied to other type of emergency such as illegal entry.

In step S2, one of a plurality of predetermined guiding schemes corresponding to the sensors of the hazard processing apparatus is chosen according to the status information of the actuated sensors in the alarm signal. In the illustrated embodiment, each of the predetermined guiding schemes includes various sets of the status of the sensors which are essential conditions in choosing the schemes, and a list of terminal devices 230 of the hazard processing apparatus 200 to be enabled. In addition, the terminal devices 230 can be alarms such as buzzers. In other embodiments, the predetermined guiding schemes can include other types of parameters, and the terminal devices 230 can be other types of devices such as fire extinguishers, for fire safety related conditions.

In step S3, an operation is performed according to the chosen scheme, thereby responding to the event. In the illustrated embodiment, the operation includes transmitting a control signal to the hazard processing apparatus 200, thereby enabling the terminal devices 230 of the hazard processing apparatus 200 in the list of the terminal devices 230. The operation further includes enabling an output unit to display a guide map according to the chosen predetermined guiding scheme, wherein the guide map includes a floor plan corresponding to the scene where the sensors are located. The location of the sensors are indicated on the floor plan, and an allowed route and a disallowed route are distinguishably displayed from each other on the floor plan. The operation further includes enabling an output unit to output a warning message including a timer of allowable evacuation time, wherein the allowable evacuation time is provided corresponding to the status information of the actuated sensors in the alarm signal. In addition, in the illustrated embodiment, the operation includes transmitting a control signal for informing a client corresponding to a protection region of the actuated sensors, while the sensors of the hazard processing apparatus 200 correspond to at least one protection region, thereby enabling an output unit to output a warning message.

The disclosed emergency guiding method chooses one of the predetermined guiding schemes according to the status information of the actuated sensors in the alarm signal, such that evacuation routes can be shown in a dynamic manner and updated corresponding to the instant situation of emergency. Consequently, real time evacuation guidance can be provided during emergency.

As shown in FIG. 4B, choosing the step of the emergency guiding method (S2 of FIG. 4) of the present disclosure is as follows. Depending on the embodiment, additional steps may be added, others removed, and the ordering of the steps may be changed.

In step S21, a possibility to evacuate according to the actuated sensors is determined. If there is a possibility to evacuate (that is, there is a path to escape from the scene of emergency), step S22 is implemented; otherwise (that is, there is no path to escape from the scene of emergency), step S23 is implemented.

In step S22, one of the plurality of evacuation schemes corresponding to the sensors of the hazard processing apparatus 200 is chosen according to the status information of the actuated sensors in the alarm signal.

In step S23, one of the plurality of refuge schemes corresponding to the sensors of the hazard processing apparatus 200 is chosen according to the status information of the actuated sensors in the alarm signal.

In the illustrated embodiment, the evacuation schemes and the refuge schemes correspond to the sensors of the hazard processing apparatus, wherein the evacuation schemes and the refuge schemes are predetermined schemes for emergency guiding. In addition, the evacuation schemes and the refuge schemes are determined according to the status of the sensors such as the location, the type, the detected parameters, or the actuation time of the sensors. Each of the evacuation schemes and the refuge schemes includes various sets of the status of the sensors which are essential conditions in choosing the schemes, and a list of the terminal devices 230 to be enabled. In other embodiments, other types of predetermined guiding schemes can be chosen, and the schemes can be chosen by other methods such as according to an instruction received from the user. In addition, the evacuation schemes and the refuge schemes can be determined according to other parameters relating to the sensors, and each of the evacuation schemes and the refuge schemes can include other types of parameters.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An emergency guiding system, comprising:
a control unit;
a determination unit receiving an alarm signal from a hazard processing apparatus including a plurality of sensors, wherein the alarm signal includes status information of the actuated sensors; and
a database unit including a plurality of predetermined guiding schemes corresponding to the sensors;
wherein the determination unit chooses one of the predetermined guiding schemes according to the status information of the actuated sensors in the alarm signal, the control unit performs an operation according to the chosen predetermined guiding scheme.

2. The system of claim 1, wherein the predetermined guiding schemes are separated into a plurality of evacuation schemes and refuge schemes, the determination unit determines whether there is a possibility to evacuate according to the actuated sensors, one of the evacuation schemes is chosen when there is a possibility to evacuate, one of the refuge schemes is chosen when there is no possibility to evacuate.

3. The system of claim 1, wherein the hazard processing apparatus further includes a plurality of terminal devices, each of the predetermined guiding schemes includes a list of the terminal devices to be enabled, the operation of the control unit includes transmitting a control signal for enabling the terminal devices in the list to the hazard processing apparatus.

4. The system of claim 1, further comprising an output unit, wherein the operation of the control unit includes enabling the output unit to display a guide map according to the chosen predetermined guiding scheme.

5. The system of claim 4, wherein the guide map includes a floor plan corresponding to the scene where the sensors are located, the location of the sensors are indicated on the floor plan.

6. The system of claim 4, wherein the sensors correspond to at least one protection region, the operation of the control unit includes transmitting a control signal for informing a client corresponding to the protection region of the actuated sensors.

7. The system of claim 1, further comprising an output unit, wherein the operation of the control unit includes enabling the output unit to output a warning message.

8. The system of claim 7, wherein the warning message includes a timer of allowable evacuation time corresponding to the status information of the actuated sensors in the alarm signal.

9. The system of claim 1, further comprising a processing unit corresponding to the hazard processing apparatus, wherein the determination unit receives the alarm signal from the hazard processing apparatus through an interface adapter including a computer network interface coupled to the emergency guiding system and a serial communication interface coupled to the hazard processing apparatus; the processing unit derives the status information of the actuated sensors of the hazard processing apparatus from the alarm signal received from the interface adaptor.

10. An emergency guiding method, comprising the following steps:
receiving an alarm signal including status information of actuated sensors of a hazard processing apparatus;
choosing one of a plurality of predetermined guiding schemes corresponding to the sensors of the hazard processing apparatus according to the status information of the actuated sensors in the alarm signal; and
performing an operation according to the chosen predetermined guiding scheme.

11. The method of claim 10, wherein the predetermined guiding schemes are separated into a plurality of evacuation schemes and refuge schemes, the step of choosing one of the predetermined guiding schemes includes:
determining whether there is a possibility to evacuate according to the actuated sensors;
if there is a possibility to evacuate, choosing one of the evacuation schemes; and
if there is no possibility to evacuate, choosing one of the refuge schemes.

12. The method of claim 10, wherein each of the predetermined guiding schemes includes a list of terminal devices of the hazard processing apparatus to be enabled, the operation includes transmitting a control signal for enabling the terminal devices of the hazard processing apparatus in the list to the hazard processing apparatus.

13. The method of claim 10, wherein the operation includes enabling an output unit to display a guide map according to the chosen predetermined guiding scheme.

14. The method of claim 13, wherein the guide map includes a floor plan corresponding to the scene where the sensors are located, the location of the sensors are indicated on the floor plan.

15. The method of claim 13, wherein the sensors correspond to at least one protection region, the operation includes transmitting a control signal for informing a client corresponding to the protection region of the actuated sensors.

16. The method of claim 10, wherein the operation includes enabling an output unit to output a warning message.

17. The method of claim 16, wherein the warning message includes a timer of allowable evacuation time corresponding to the status information of the actuated sensors in the alarm signal.
